(19) United States
(12) Patent Application Publication
(10) Pub. No.: US 2006/0190965 A1
(43) Pub. Date: Aug. 24, 2006

(54) Display method

(75) Inventors: Wan-Shan Lin, Taipei (TW); Yu-Wen Ho, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/272,701

(22) Filed: Nov. 15, 2005

(30) Foreign Application Priority Data
Feb. 21, 2005 (TW) 94105101

(51) Int. Cl. H04N 5/445; G06F 3/00; G06F 13/00; H04N 5/45

(52) U.S. Cl. 725/46; 725/45; 348/565

(57) ABSTRACT

Picture-on-picture technology is used in the present invention to divide a television screen into a main picture and suffix pictures. The main picture displays the selected channel. The three suffix pictures are used to display the favorite channels. Then, users can preview and browse the favorite channels.

### RELATED APPLICATIONS

The present application is based on, and claims priority from, Taiwan Application Serial Number 94105101, filed Feb. 21, 2005, the disclosure of which is hereby incorporated by reference herein in its entirety.

### FIELD OF THE INVENTION

The present invention is about a display method, and more particularly is about a method to display favorite channels.

### BACKGROUND OF THE INVENTION

For a long time, daily image information has been provided by television. People can know the weather information, the latest news and entertainment information from television. Today, with the development of information, more and more channels are provided by television.

However, of these channels, each user has his favorite channels. Therefore, when a user turns on a television, the first work is to find his favorite channel. Once the user changes his favorite, the channel search has to be repeated again. When more and more channels are provided, such channel searching takes a lot of time.

Therefore, typically, a favorite channel setting is provided by the television. According to the typical method, the user pre-sets several channels as his favorite channels. After setting the favorite channels, the channels provided to the user will be limited to these favorite channels. Such method reduces searching time, but it is possible for a user to lose the information not provided by these favorite channels.

### SUMMARY OF THE INVENTION

Therefore, the main purpose of the present invention is to provide a method to display the favorite channels and the usual channels, together, for a user.

The other purpose of the present invention is to provide a user with a method to preview the content of channels.

According to the foregoing purposes, the present invention provides a display method used on a screen of a television system. A screen is divided into a main picture and three suffix pictures. The main picture is used to display information of the channel selected from all channels. The three suffix pictures are used to display the information of the channels selected from the favorite channels. Moreover, a user can sequentially browse all favorite channels through the three suffix pictures.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a screen according to the preferred embodiment of the present invention.

### DETAILED DESCRIPTION OF THE PREFERRED EMBODIMENT

The display method provided by the present invention improves channel selection efficiency. Moreover, the usual channel and the favorite channel can be displayed on the screen together. Therefore, the user receives any information of interest. The following will detailed describes the technology of the present invention.

A television is connected to a cable used to transfer a lot of audio and video information to the television. Typically, the screen of a television only displays information from one channel. Moreover, even though the Picture-on-Picture display technology is used on a television to display multiple channel contents on its screen, the channels are still selected from all channels. In other words, this technology does not necessarily reduce the searching time. It is noted that the method of the present invention can be used for various displays, and not only for a television.

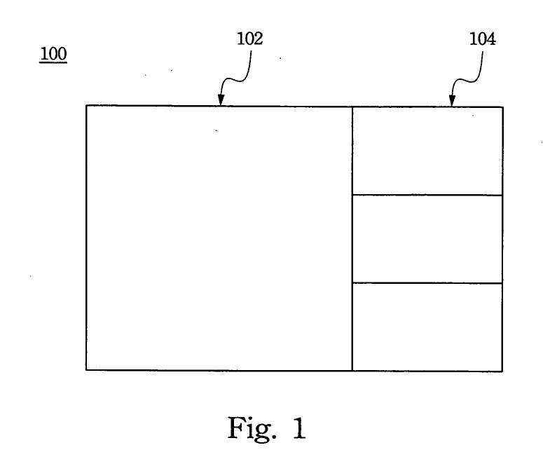

Therefore, the main characteristic of the present invention is use of the picture-on-picture technology to display the favorite channels. It is noted that the display method disclosed by the present invention can be used in various displays. FIG. 1 illustrates a screen using the method of the present invention to display channels. POP3 (picture-on-picture 3) technology is used to divide the screen. In other words, the screen 100 is divided into one main picture 102 and three suffix pictures 104 according to the preferred embodiment, In other embodiments, other dividing screen technology, such as POP4 or POP5, can also be used in the present invention.

The main picture 102 is used to display the channel selected from all channels. The suffix pictures 104 are used to display the channels selected from the favorite channels. In other words, when displaying, a channel signal from the cable is displayed in the main picture 102 and three favorite channel signals from the cable are also displayed in the suffix pictures 104. Therefore, according to the present invention, a user can watch not only the channel selected from all channels but also the channels selected from the favorite channels. Moreover, the favorite channels displayed in the suffix pictures 104 can be sequentially switched for users to browse all favorite channels. The sequential switching direction can be forward or backward. For example, if the three suffix pictures 104 respectively display the first, second and third favorite channel now, the displayed channels will be changed to the second, third and fourth favorite channel when using forward switching. On the other hand, if the three suffix pictures 104 respectively display the second, third and fourth favorite channel now, the displayed channels will be changed to the first, second and third favorite channel when using backward switching.

The channel displayed in the main picture 102 may also be changed according to user requirements when browsing the favorite channels. In other words, according to the display method of the present invention, the favorite channels and the usual channels may be displayed together for a user. A user can receive information from either the usual channel or from the favorite channel. Moreover, the channel displayed in the main picture 102 may be changed at any time while browsing the favorite channels. Therefore, the display method of the present invention completely resolves the problem of a screen limited to displaying the favorite channel when switching to favorite channel function.

On the other hand, the user can directly transfer the channel displayed in any suffix picture 104 to the main picture 102 while browsing the favorite channels. Such a direct transfer function may simplify the setting of favorite channels. For example, when a user finds an interesting channel in the main picture 102, he can directly transfer this interesting channel from the main picture 102 to any suffix picture 104 to finish the favorite channel setting. On the other hand, when a user wants to cancel a favorite channel setting, he can directly cancel this favorite channel from suffix picture 104. In other words, according to the present invention, setting favorite channels can be easily finished by directly transferring any interesting channel from the main picture to any suffix picture.

Accordingly, the channel display method of the present invention displays the channel selected from all channels and the channel selected from the favorite channels, together. Therefore, the user can receive information of any sort, from either the usual channels or the favorite channels. Moreover, the user can browse the favorite channels while watching the channel selected from the usual channels. On the other hand, when setting favorite channels, the user may directly transfer any interesting channel from the main picture to any suffix picture to finish the setting.

As is understood by a person skilled in the art, the foregoing preferred embodiments of the present invention are illustrative of the present invention rather than limiting of the present invention. It is intended that this description cover various modifications and similar arrangements included within the spirit and scope of the appended claims, the scope of which should be accorded the broadest interpretation so as to encompass all such modifications and similar structure.

What is claimed is:

1. A display method used on a screen of a television system, wherein said television system receives a plurality of channel signals related to a plurality of channels and some of said channels are set as favorite channels, said method comprising the steps of:
receiving one of said channel signals for displaying in a main picture;
receiving some of said channel signals of said favorite channels for displaying in a plurality of suffix pictures; and
using picture-on-picture technology to display said main picture and said suffix pictures on said screen, wherein said main picture is used to display any one of said channels, said suffix pictures are used to display some of said favorite channels, and said favorite channels are sequentially displayed in said suffix pictures.

2. The method according to claim 1, wherein said picture-on-picture technology is POP3 technology.

3. The method according to claim 1, wherein said screen comprises three suffix pictures for displaying three favorite channels.

4. The method according to claim 1, wherein said main picture channel and any one of said suffix picture channel are switched to each other.

5. A screen display method used in a screen, wherein said display receives a plurality of channel signals related to a plurality of channels, said method comprising the steps of:
selecting a plurality of favorite channels from said channels;
receiving some of said channel signals of said favorite channels for display in a plurality of suffix pictures; and
using a picture-on-picture technology to display a main picture and said suffix pictures in said screen, wherein said main picture is used to display any one of said channels, said suffix pictures are used to display some of said favorite channels, and said favorite channels are sequentially displayed in said suffix pictures.

6. The method according to claim 5, wherein said picture-on-picture technology is POP3 technology.

7. The method according to claim 5, wherein said screen comprises three suffix pictures to display three favorite channels.

8. The method according to claim 5, wherein said main picture channel and any one of said suffix picture channel are switched to each other.

9. A method to adjust the favorite channels used in a screen of a television system, wherein said television system receives a plurality of channel signals related to a plurality of channels, said method comprising the steps of:
using picture-on-picture technology to display a main picture and a plurality of suffix pictures on said screen, wherein said main picture is used to display any one of said channels, said suffix pictures are used to display some of said favorite channels, and said favorite channels are sequentially displayed in said suffix pictures;
selecting one favorite channel displayed by said suffix pictures; and
canceling said selected favorite channel.

10. The method according to claim 9, wherein said picture-on-picture technology is POP3 technology.

11. The method according to claim 9, wherein said screen comprises three suffix pictures for displaying three favorite channels.

12. The method according to claim 9, wherein said main picture channel and any one of said suffix picture channel are switched to each other.
